(19) United States
(12) Patent Application Publication
(10) Pub. No.: US 2014/0331744 A1
(43) Pub. Date: Nov. 13, 2014

(54) SAMPLE INTRODUCTION DEVICE AND METHOD

(71) Applicants: Wilhelm Matthijs Adriaan Van Egmond, Echt (NL); Ynze Mengerink, Echt (NL)

(72) Inventors: Wilhelm Matthijs Adriaan Van Egmond, Echt (NL); Ynze Mengerink, Echt (NL)

(73) Assignee: DSM IP ASSETS B.V., Heerlen (NL)

(21) Appl. No.: 14/238,308

(22) PCT Filed: Aug. 13, 2012
(86) PCT No.: PCT/EP2012/065809

§ 371 Date: Jun. 11, 2014

(30) Foreign Application Priority Data
Aug. 11, 2011 (NL) 2007260
Dec. 23, 2011 (EP) 11195606.6

(51) Int. Cl. G01N 30/16; H01F 41/04; H05B 6/36

(52) U.S. Cl. CPC G01N 30/16; H05B 6/36; H01F 41/04
USPC 73/23.41; 219/635; 29/606

(57) ABSTRACT

The present invention relates to an injector for use in gas phase analytical systems and methods comprising a metal housing, provided with a carrier gas inlet, a split outlet, a column outlet of the injector, a sample inlet, a liner, and a heater device comprising at least one coil for radio frequency inductive heating the housing with a predetermined temperature program and for providing a predetermined spatial temperature profile in the injector. The injector according to the invention allows performing gas phase analyses, especially GC analyses with reduced discrimination. Advantages of heating with a heater device comprising a coil for inductive heating include a homogeneous heating profile of the housing including parts connected thereto, with heating rates that can be varied widely. A further advantage is that the injector can be operated as a conventional S/SL injector at a predetermined temperature, or as PTV injector or thermal desorption injector with certain predetermined temperature programs. The invention also relates to a process of making an injector according to the invention, and to a process of refitting an existing S/SL injector. The invention further concerns a gas analytical system comprising an injector according to the invention, and to a process of analysing a sample with such gas analytical system.

### TECHNICAL FIELD

The present invention relates generally to gas phase analytical techniques, like gas chromatography (GC), and more specifically to a sample introduction device (hereinafter also called injector) for use in gas phase analytical systems and methods. In particular the invention relates to a Programmed Temperature Vaporising (PTV) injector.

The present invention also relates to a process of making an injector according to the invention, and to refitting an existing split/splitless (S/SL) injector with a heater device forming part of the injector of the invention. The invention further concerns a gas phase analytical system comprising an injector of the invention, and a process of analysing a sample with such a gas analytical system, like a GC system.

### BACKGROUND ART

Gas chromatography is a commonly applied gas phase analytical technique for analysing a sample, which sample may include one or more compounds (also called analytes) that can be vaporised. GC can be used to qualitatively identify analytes in a sample as well as to quantitatively determine the (relative) concentrations of the analytes. GC analysis typically involves a series of steps, including sample collection, sample preparation, sample introduction into a system and transfer to a chromatographic column, chromatographic separation of the sample into (individual) analytes, detection of such analytes, and data acquisition and processing. In gas chromatography a gaseous mobile phase, generally an inert carrier gas like helium or nitrogen, flows along a stationary phase, typically a thin layer of liquid or polymer on inert solid support material inside a glass or metal tubing, called a column. Conventionally small support particles were packed in a column, whereas currently capillary columns are applied, wherein the internal surface of narrow glass tubing has been provided with material functioning as stationary phase. Such capillary columns typically have a length of several meters, and are used as winded rolls.

The gaseous compounds being analysed pass with the carrier gas through the column and interact with the stationary phase depending on the type of molecule. This causes each compound to progress or elute through the column at its own specific rate, resulting in a so-called compound dependent retention times. Analytes can be identified by the order in which they emerge from the column and by comparing with retention times of known compounds, using one or more detectors.

In order to conduct GC analysis a gas chromatograph or GC system is used, which system typically comprises:
a sample introduction device, also referred to as (sample) injector or port, to receive the sample and to evaporate and mix it with a flow of carrier gas;
a system for controlling pressures and flow rates of carrier gas and other gas flows;
a separation column through which the analytes progress, generally contained in a temperature programmable oven;
one or more detectors for measuring the presence of each of the analytes after leaving the column; and
a data acquisition and processing system.

A GC system may further comprise an auto-sampler system for automatically providing samples to the sample introduction device, instead of doing this manually, with for example a syringe and needle or other sample transfer device.

Due to the great variety of available separation columns and detectors, and the diversity of samples that may be analysed, a number of different sample introduction devices have been developed. Typically, an injector includes a sample inlet via which a quantity of sample (generally in liquid form, for example a solution of analytes in a solvent) is injected with a syringe, after which it is prepared for delivery to the column. Additionally several other types of sample introduction devices are known that allow other than syringe injection, like gas or liquid sampling valves, headspace auto-samplers, thermal desorption devices, purge and trap samplers, and pyrolysers.

The most commonly used sample introduction device in GC analyses of liquid sample is the so-called split/splitless (S/SL) injector. Such S/SL injector basically comprises
a receiving chamber (also called housing or body), provided with
an inlet for a carrier gas flow (also called carrier gas inlet),
an optional outlet for a septum purge gas flow (also called septum purge outlet),
an outlet for a split purge gas flow (also called split outlet),
an outlet connecting to the column (also called column outlet of the injector),
a sample inlet, like a septum through which a needle may be inserted,
a sample container (also called liner) for receiving sample, and evaporating and mixing sample with the carrier gas flow; and
a heater device for controlling the temperature of the injector.

The liner or sample container is typically an open ended glass tube, and may have various internal geometries to enhance e.g. sample evaporation or mixing with the carrier gas. The liner may also comprise a sample retainer, like glass wool, for enhancing sample introduction, e.g. via temporarily receiving and/or adsorbing a liquid sample after injection. Presence of a sample retainer may also aid in mixing the sample with carrier gas. In a specific embodiment, such a liner may comprise a sample retainer with pre-interacted gaseous sample, which sample is desorbed after bringing the liner into the injector housing. In such case the liner can also be called a thermal desorption tube. The liner can be (re)placed in the injector via the sample inlet opening of the housing.

Generally the heater device of an S/SL injector comprises a heater controller and a heating block surrounding at least part of the housing. The heating block traditionally comprises a heat conducting material like a metal or a ceramic that is operated as an electrical resistive heater and a temperature sensor.

The septum purge outlet allows generating a mild continuous gas flow along the sample inlet to remove potentially contaminating compounds.

The split outlet flow can be varied to remove or exhaust part of the evaporated sample with carrier gas from the injector; that is to only feed part of the sample or the full sample to the column. Splitting is often desired to prevent overloading of the column, and depends on the type and concentrations of analytes in the sample. The ratio between gas flows leaving the injector via the split outlet and entering the column via the column outlet of the injector may vary widely, and can be e.g. 50:1. Operating the injector and GC system with or without a split purge flow is referred to as split- or splitless-mode, respectively. In case sample contains only traces of compounds to be analysed, splitless mode operation may be preferred.

Generally, the injector is mounted to a GC system such that the sample inlet is easily accessible from outside of the GC, but at least the part of the housing comprising the liner and column outlet of the injector is placed inside the column oven; for example via an opening on top of the oven. The injector part within the oven is typically surrounded by the heating block of the heater device, to set injector temperature independent of oven temperature.

In a typical way of operating such S/SL injector, a liquid sample of about 1 μl or less is provided with a sample transfer device like a needle and syringe through the resilient septum into the liner, which is kept at a set temperature typically in the range 40-450° C., depending on the evaporation temperatures of the analytes and solvent. The injected sample will be heated and evaporated, which can result in a 500-1000 fold volume increase. This explosive and uncontrolled growth in volume within the liner, which typically has a volume of about 0.5-1 ml, may result in non-plug flow of sample/carrier gas, and in sample even going against the carrier gas flow resulting in contamination of the injector. These effects result in so-called discrimination; meaning that not all sample components—especially higher boiling analytes—representatively enter the column. In addition, by injecting into a hot sample container evaporation of sample may already start in the needle, further increasing said discrimination effect. Discrimination effects are discussed in more detail in for example K. Grob, Classical Split and Splitless Injection in Capillary GC (Hüthig Verlag, 1988, ISBN 3-7785-1562-4).

In order to reduce such discrimination effect, various modified injectors have been developed. For example, a cold-on-column (COC) injector is not heated and allows liquid sample to be directly injected to the beginning of the column; after which the oven heating programme is started. Theoretically this technique provides almost ideal sample introduction with respect to discrimination, but disadvantages include the very small sample volume that should be used (which is difficult to dose), and possible column contamination with non-volatile compounds present in the sample.

An improved version of an S/SL injector is the so-called Programmed Temperature Vaporising (PTV) injector. The liquid sample is now introduced in the liner of the injector at relatively low initial temperature preferably below the solvent boiling point, after which the injector is heated with a programmed temperature ramping; resulting in more controlled evaporation, more homogeneous gas flow, and reduced discrimination. After running the sample, the PTV injector may be cooled along with the column oven, or by additional cooling means, to prepare for receiving a next sample.

Such a PTV injector is for example known from U.S. Pat. No. 6,907,796B2. The injector described in this publication comprises a metal housing (herein called receiving tube), provided with a carrier gas inlet, a split outlet, a column outlet of the injector, a sample inlet, a liner (herein called injector tube), and a heater device for controlled heating and cooling the housing. The heater device comprises a heater controller and a metallic tube coil provided on the housing, which tube coil is simultaneously designed as resistance heating coil to allow rapid heating, and as cooling coil through which coolant can flow to achieve additional cooling of the injector. The tube coil is preferably provided in contact with the housing in such way that a temperature distribution over the housing as uniform as possible is achieved. Use of a septum purge flow is not needed in such PTV injector, but optional; the sample being injected into a cold liner and heated afterwards already reducing contamination at the inlet.

A drawback of the known injectors is that the discrimination effect is not completely overcome, specifically not for samples containing less volatile compounds. There is thus still a need in industry for an improved injector that can be used with different samples and which shows little discrimination in e.g. GC analysis.

### DISCLOSURE OF THE INVENTION

The present invention provides such improved sample introduction device or injector for use in gas phase analytical systems and methods by the embodiments as described herein below and as characterised in the claims.

Accordingly, the present invention provides such an injector for use in gas phase analytical systems and methods comprising a metal housing, provided with a carrier gas inlet, a split outlet, a column outlet of the injector, a sample inlet, a liner, and a heater device comprising at least one coil for radio frequency inductive heating the housing with a predetermined temperature program and for providing a predetermined spatial temperature profile in the injector.

By temperature program is herein meant a temperature variation in time.

The injector according to the invention allows performing gas phase, especially GC analyses with reduced discrimination, resulting from well-controlled heating and providing a certain temperature profile or gradient in the housing from sample inlet to column outlet of the injector with induction heating means. An advantage of heating with a heater device comprising a coil for inductive heating is homogeneous heating of the housing including parts connected thereto, like nuts and ferrules. This prevents that relatively colder zones or cold spots are formed in the injector, which otherwise could cause undesired condensation of higher boiling compounds. A further advantage is that heating rates and programmes can be varied widely.

By temperature profile is herein meant a spatial distribution of temperature in the injector and hence the term spatial temperature profile is used with the same meaning. This is also referred to a temperature gradient through the injector.

A further advantage is that the injector can be operated as a conventional S/SL injector pre-heated at a predetermined temperature (and spatial temperature profile), or as PTV injector or thermal desorption injector with certain predetermined temperature programs.

The injector can advantageously be used in various gas phase analytical systems and methods; especially in GC analyses, but also for other techniques like direct-inlet mass-spectrometry (MS).

The injector according to the invention comprises, except for its heater device, typically components similar as in known S/SL and PTV injectors. The injector may also further comprise a septum purge outlet, which is generally used for conventional S/SL type of operation with sample transferred into a pre-heated liner, but this outlet may be closed during use as PTV injector.

The injector according to the invention comprises a metal housing, which is within the context of this application understood to mean that the housing is made from or comprises an electrically conductive material, which increases in temperature when exposed to the electromagnetic field generated by alternating currents in the coil for inductive heating. This material typically is a metal, but can also be another conductive material like a ceramic.

In an embodiment of the invention the housing is essentially made of a conductive metal, which provides both form and stability, and which can be induction heated.

In another embodiment of the invention the housing is made of a combination of conductive and non-conductive materials. For example, the housing may comprise a body providing its structural form but which is non-conductive; in combination with conductive elements in the form of e.g. a coating, a sheet or foil, or strips. Such conductive elements can be attached to the housing body both on the outside, and/or on the inside of the housing.

The metal housing of the injector according to the invention is induction heated mainly by so-called Joule heating, resulting from Eddy currents generated in the conductive metal housing (or elements thereof). Additionally, some heat may be generated by magnetic hysteresis losses, if the material of the housing shows significant relative permeability. Therefore, in a further embodiment of the invention the housing is made from or comprises a ferromagnetic material, like iron or a stainless steel grade.

In a preferred embodiment of the invention the injector comprises a housing that is essentially made from a ferromagnetic material.

The injector according to the invention comprises a heater device with at least one coil for inductive heating. The coil for inductive heating can be made from any material having low electrical resistance and allowing alternating high currents to be induced in the coil by a heater controller. A person skilled in the art will be able to select a suitable material. The coil for inductive heating is preferably made from a conductive metal, like copper.

The at least one coil for inductive heating in the injector according to the invention has such coil dimensioning and is arranged by the housing in such way, that the induction field provided by coil and heater controller provides sufficient energy to heat the housing to desired temperatures and at desired heating or ramp rates. The coil can have various cross-sectional geometries, for example a cylindrical wire or an oval or flattened tape. The coil for inductive heating in the injector may be arranged for example above, below, on one or more sides, around the house of the injector or any combination of the these arrangements. However, it is preferred that the coil for inductive heating is wound around the house of the injector, as this allows for simple design of the coil for heating of the housing—particularly when refitting an existing S/SL injector into forming an equipment comprising an injector according to the invention.

The at least one coil for inductive heating in the injector according to the invention allows heating the housing with a predetermined temperature program; which program can be adjusted and controlled in cooperation with the heater controller. The temperature program may result in a steady increase in temperature, but also in for example step-wise heating.

In an embodiment of the invention the coil for inductive heating of the heater device enables heating the housing at widely varying ramp rates, of for example up to 100° C./s; also depending on heater controller capacity or power, and mass of parts to be heated. Preferably, coil for inductive heating and heater controller are chosen such that the injector according to the invention can be heated with a ramp rate of at least 1, 2, 5 or 10° C./s. Typically, the ramp rate will be in the range 1-100, 2-60, or 5-40° C./s.

In an embodiment of the invention, the coil for inductive heating is provided in such way that induction heating of the injector is not limited to heating the body of housing, but includes heating of induction heatable parts connected thereto, like outlets and inlets with nuts, ferrules, connections, etc, Preferably, at least the column outlet of the injector is effectively heated. Heating all elements (including elements with high thermal mass) of the housing will minimize cold spots. Temperature ramping promotes an undisturbed flow of gas mixture with significantly reduced chance of condensation of components on colder parts of the housing. Heating to arrive at a certain spatial temperature profile over the housing further reduces discrimination. To achieve both temperature ramping and spatial temperature profile, according to this embodiment the coil for inductive heating is placed around the housing until at least the column outlet of the injector, and ferrule and nut connecting the column to the housing. The coil for inductive heating is preferably placed around the housing as far as possible; preferably an induction heated zone is created from the beginning of the liner to the column outlet of the injector, to prevent cold spots can be formed.

In the heater device of the injector according to the invention the coil for inductive heating is typically spirally wound around the housing. The coil can be wound regularly at constant distance between the windings, but preferably the coil is wound with a varying distance between windings; that is with varying winding density. Preferably, winding density is chosen such that the energy profile generated takes into account differences in mass of the parts or zones to be heated, such that a predetermined temperature and spatial temperature profile can be effectively provided. Such spatial temperature profile can be a flat or constant profile, but can also be a decreasing or increasing temperature along the injector or any combination of these.

In a highly preferred embodiment, at least one coil for inductive heating is provided in such way that a spatial temperature profile with monotonically increasing temperature from sample inlet of the injector to the column outlet of the injector is provided. This may for example be realized by varying the coil winding density of the coil for inductive heating of the injector; by varying the material or dimension of the coil for inductive heating; by varying the type of material or amount of material of the housing in the injector. It is preferred to achieve a monotonically increasing temperature from sample inlet of the injector to the column outlet of the injector by varying the coil winding density along the length of the injector.

In an embodiment of the invention winding density of the coil for inductive heating increases, e.g. the distance between windings of the coil for inductive heating decreases, from sample inlet to column outlet of the injector; the winding density being the highest at column outlet of the injector. This has the advantage that a predetermined increasing spatial temperature profile or gradient can be more easily provided and maintained.

In an alternative embodiment, a first coil for inductive heating is provided around the housing, preferably at regular winding density and around a major part of the housing until column outlet of the injector, and a second coil for inductive heating is provided at the zone at the column outlet of the injector, for even better control of the spatial temperature profile or gradient. This way an increasing spatial temperature profile can be effectively provided with the housing having the highest temperature at the column outlet of the injector.

In an embodiment of the invention the at least one coil for inductive heating is provided in such way that the an increasing spatial temperature profile can be provided during operation, wherein the temperature at the column outlet of the injector is at least about 1° C. higher than at the sample inlet of the induction heated housing. Such increasing spatial temperature profile, and especially the highest temperature of the injector being at the column outlet of the injector further reduces the discrimination effect. Preferably, the temperature profile is such that the temperature at column outlet of the injector is at least about 2° C. higher than at the other parts, especially than at the sample inlet of the housing. More preferably, the temperature at column outlet of the injector is about 5, 10, 15, 20, 25, or even 30° C. higher, to further suppress discrimination effects.

The at least one coil for inductive heating in the heater device of the injector according to the invention is preferably not in contact with the metal housing, but at a certain distance from its surface to prevent short circuiting. As efficiency of energy transfer from coil to housing will decrease with increasing distance, the distance between coil and housing is kept as small as practically possible. For these reasons the coil for inductive heating is preferably electrically isolated from the housing, for example by providing a non-conductive isolation layer between coil and outer surface of the housing. Any suitable electrical isolation material can be used for this purpose, as long as it allows inductively heating the housing.

In an embodiment of the invention a glass layer, for example a glass tube in case of a cylindrical housing, is present as an isolation layer between coil for inductive heating and housing of the injector.

In a preferred embodiment of the invention the coil for inductive heating is attached to the isolation layer, like a glass tube; which simplifies placing or mounting (and demounting) of the coil around the—typically cylindrical—injector housing. The combination of coil for inductive heating attached to an isolation layer is also referred to as a heating element.

In another embodiment of the invention the heater device comprises a heating element comprising at least one coil for inductive heating enclosed in a non-conductive container or housing, like a double-walled tubular glass container. The heating element or container is preferably further provided with connecting means to connect the coil to the heater controller. The advantages of such heating element comprising at least one coil for inductive heating within a container include easy mounting and demounting of the heating element, electrically isolating the coil from injector housing, protecting the coil from external influences, and increasing safety in operation. Preferably, the container of the heating element is also provided with an inlet and outlet for a gas flow. Providing a gas flow through the container, preferably of an inert gas, will extend the life-time of the coil (and heating element), and can also be used to control the temperature of the coil and heating element. The gas flow can also be used for cooling the coil for inductive heating, housing and heating element after an experiment in PTV operation mode, to prepare for a subsequent analysis run.

The heater device of the injector according to the invention comprises at least one coil for inductive heating and a heater controller. The heater controller provides the energy to the coil for inductive heating to enable the injector is heated with an adjustable and controllable, predetermined temperature program and is provided with a predetermined spatial temperature profile. In order to heat the housing, the heater controller supplies alternating current (AC) to the at least one coil for inductive heating with a voltage and frequency chosen dependent on type of coil and material and mass of the housing, to generate enough energy to allow desired heating rates, and maintaining desired spatial temperature profile. The skilled person is able to determine suitable conditions based on some experiments. It was found to be advantageous to utilize radio frequency AC. Radio frequency is herein considered a frequency of 2 kHz to 1 GHz. Preferably the radio frequency AC of the coil for inductive heating is 5 kHz to 100 kHz and most advantageous radio frequency AC with a frequency of 10 kHz to 40 kHz is used.

The heater controller of the heater device is preferably connected to and communicating with at least one sensor, placed on or in the housing of the injector within the electro-magnetic (induction) field generated by the coil for inductive heating. Such feedback system enables better control over the energy supplied by the field to heat with a desired temperature program, and to reach and maintain a predetermined spatial temperature profile. Different types of sensors can be applied, as long as they provide a signal responsive to or representative of temperature (difference).

The heater device can heat the injector with an adjustable, predetermined temperature program. Such program can include heating at a set ramp rate, but also a more complex program with different ramp rates in different temperature ranges and/or temperature plateau(s) with holding time(s). Heating at certain ramp rate to a predetermined temperature (and spatial temperature profile) is typical for operating the injector in PTV mode. The heating program may alternatively include isothermally heating at predetermined temperature and/or spatial temperature profile, which corresponds to the standard S/SL type of operating.

It is to be noted that the heating element and heater controller of the heater device of the present invention are not designed and applied to heat the liner or sample container to the Curie temperature or Curie point of the liner or sample container. Such type of induction heating is applied for very quickly heating a material and sample to such high temperature that the sample rapidly evaporates or even decomposes; for example in injection or other devices for thermally desorbing and/or pyrolysing a component, from an induction heatable sample probe. Such devices designed for heating the probe to one certain temperature, i.e. to the Curie point of the probe material used, are fundamentally different from the injector according to the present invention and are not suitable for use as an S/SL or as a PTV injector for GC analysis. A device utilizing inductive heating of a probe to the curie point of the probe inside the liner is disclosed in U.S. Pat. No. 5,472,670. In U.S. Pat. No. 5,472,670 it is clearly disclosed that only the probe is inductive heated for pyrolysis purposes whereas what corresponds to the house and liner is heated by resistive heating.

In the present invention, the liner/sample container (as well as the optional sample retainer) is made of inert material (so not interacting chemically with the sample) having low magnetic permeability with relative magnetic permeability, μ/μ₀, close to 1 and consist of electrically isolating material, such as glass. Thereby mainly the housing of the injector is directly induction heated by the coils for induction heating resulting in a more homogeneous and controllable heating of the liner.

The injector according to the invention as described above, basically differs from prior art standard S/SL injectors and PTV injectors in at least the type of heater device, comprising a heating element with a coil for inductive heating and a heater controller, which allows operating the injector at a chosen constant temperature (and spatial temperature profile with or without variation in temperature along the injector) as well as in PTV mode with a chosen temperature program.

The present invention therefore also relates to a process of making an injector according to the invention comprising the steps of providing a prior art S/SL injector comprising a metal housing, provided with a carrier gas inlet, optionally a septum purge outlet, a split outlet, a column outlet of the injector, a sample inlet, a liner, and a (resistance-based) heating block; removing the original resistance-based heating block from the injector; and providing at least one coil for inductive heating the housing. All above described embodiments, variations and preferred features of the injector, heating element and heater device according to the invention can be implemented similarly in this process. Particularly, it is preferred that the coil for inductive heating is arranged around the housing of the injector. This process according to the invention can be also described as a process for refitting an existing injector into forming an equipment comprising an injector according to the invention.

In an embodiment of the invention such process of refitting an existing injector, preferably an S/SL injector, comprises the steps of providing an injector comprising a metal housing, provided with a carrier gas inlet, a split outlet, a column outlet of the injector, a sample inlet, a liner, and a heating block; and replacing said heating block by a heating element comprising at least one coil for inductive heating enclosed in a non-conductive container, the container having an inlet and outlet for a gas flow, and connecting means for connecting the coil with the heater controller. In a preferred embodiment of such process, also a heater controller is provided.

The invention therefore also relates to a heating element comprising at least one coil for inductive heating enclosed in a non-conductive container, the container preferably having an inlet and outlet for a gas flow, and connecting means for connecting the coil with the heater controller. The invention further concerns a heater device comprising a heating element according to the invention and a heater controller. Such heating element and heater device according to the invention can advantageously be used to refit an existing S/SL injector.

The invention further relates to a gas phase analytical system, preferably a gas chromatography system, comprising an injector according to the invention, including all above described embodiments, variations and preferred features of the injector and heater device.

The invention also relates to a gas phase analytical system comprising the injector according to another aspect of the present invention.

The invention also relates to a process of providing a sample to a gas phase analytical system, like a GC system, according to the invention, comprising a step of providing the sample to the injector according to the invention; and to a process of analysing a sample with a gas phase analytical system, like a GC system according to the invention, comprising a step of providing the sample to the injector according to the invention; including all above described embodiments, variations and preferred features of said injector.

### BRIEF DESCRIPTION OF THE DRAWINGS

The invention is further explained by the following illustrative drawings, without being restricted thereto. In these figures like parts are indicated by the same numerals.

FIG. 1 represents a cross-sectional, schematical drawing of an S/SL injector according to the prior art;

FIG. 2 shows a cross-sectional, schematical drawing of an embodiment of the injector of the invention;

FIG. 3 shows the resulting chromatogram of Test a;

FIG. 4 shows the resulting chromatogram of Test b; and

FIG. 5 shows the combination of resulting chromatograms of Test a and Test b.

### MODE(S) FOR CARRYING OUT THE INVENTION

The present invention will be more fully described by discussing the Figures in more detail.

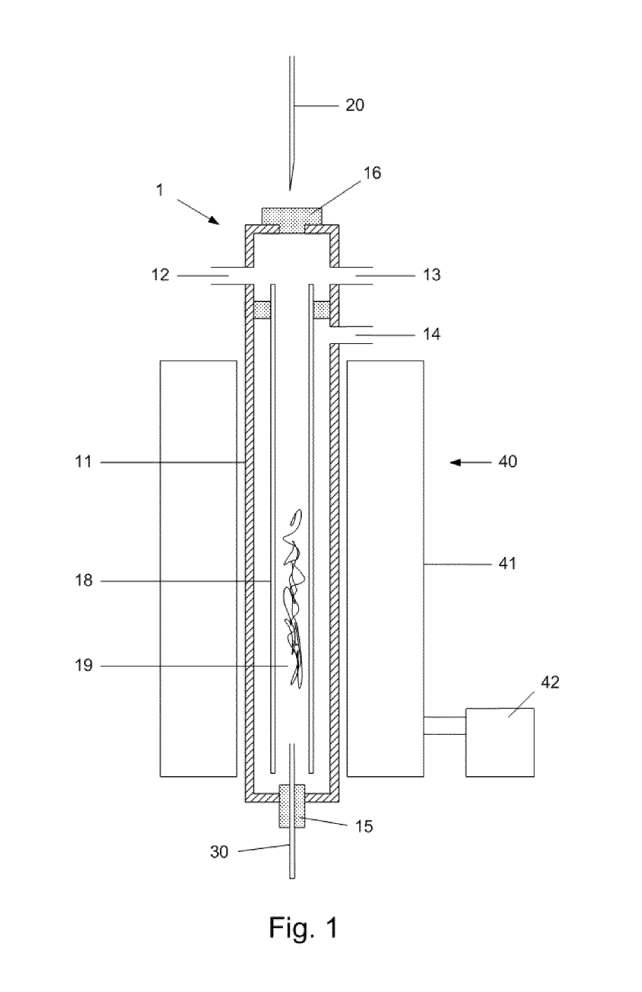

In FIG. 1 an S/SL type injector 1 according to prior art is depicted. The injector comprises a housing 11, which contains a tubular glass liner 18. The housing further comprises carrier gas inlet 12, via which a flow of inert gas is provided. A relatively small part of the carrier gas flows along septum 16 and leaves the injector via purge outlet 13, with the major part entering the liner. The carrier gas flow can also leave the injector by entering column 30 via column outlet of the injector 15, and via outlet 14 (in case of split mode operation). The lower part of the injector is placed in the oven of a GC apparatus, with typically the part with inlets 12 and 16 and outlets 13 and 14 being outside of the apparatus. The housing and the liner are heated to a chosen set temperature with heater device 40, comprising a heating block 41 with resistance heating elements controlled by heater controller 42. There further can be a temperature sensor in the heating block, or in the injector, communicating with the heater controller (not shown).

A liquid sample is transferred using a syringe and needle 20 a via rubber septum 16 into the liner and onto (optional) glass wool as sample retainer 19. The liquid sample will be heated instantaneously and evaporated explosively, and mixed and swept with the carrier gas flow towards the outlets, and at least partly enter the column at the column outlet 15 of the injector.

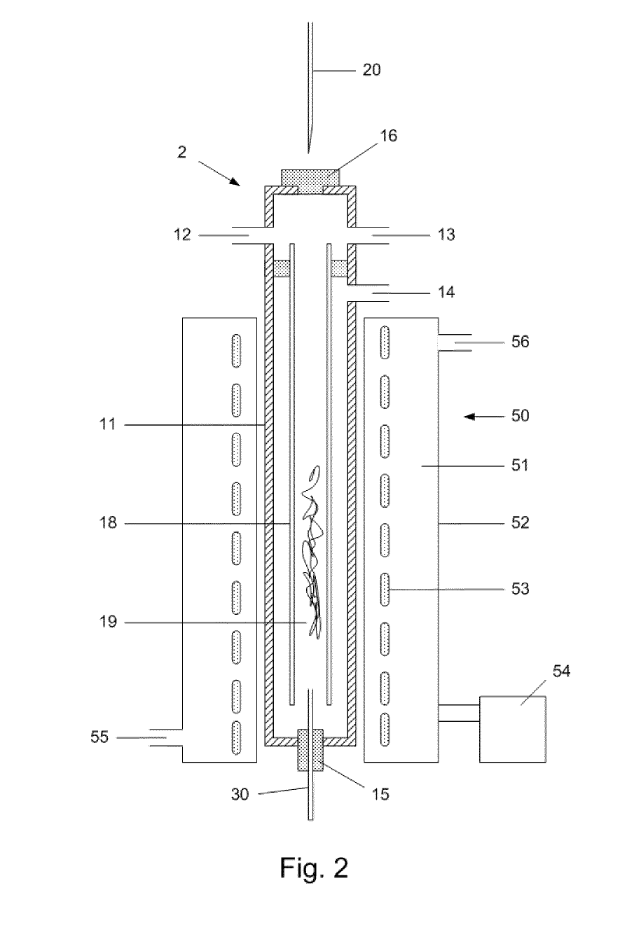

In FIG. 2 an injector 2 according to the invention is shown, which basically comprises the same components 11, 12, 13, 14, 15, 16, 18 and 19 as in FIG. 1. The liner may also comprises a sample retainer 19, onto which the liquid sample can be injected from needle 20. The main difference is in heater device 50, which comprises heating element 51 and heater controller 54. The heating element comprises double-walled tubular glass container 52 and coil for inductive heating 53, which coil is spirally wound with distance between windings being smallest in the part close to the column exit. The container further has gas inlet and gas outlet 55 and 56, for providing a gas flow through the container. The coil 53 is connected to heat controller 54, in order to inductively heat housing 11. Preferably at least one sensor is provided in or close to the housing, which sensor communicates with the heater controller (not shown). In PTV mode of operation the injector is initially at low (e.g. ambient) temperature, and a heating program is started after a sample has been transferred to the liner. Septum purge outlet 13 may in such case be closed.

The injector is used with a standard GC system applying a capillary column 30 and preferably at least one detector (not shown in FIG. 2).

### EXAMPLE

The performance of an injector according to the invention having a metal housing with coils for inductive heating arranged around the housing was tested and compared to a cold-on-column experiment under similar conditions.

### Test a:

A sample was prepared and gas chromatographic analysis was conducted on an Agilent 5890 series II with an injector according to the invention under the following settings

Sample:

Material: Polywax 655

Solvent: toluene

External calibration: C₂₈

Column: J&W DB-HT Simdis(145-1001)

Dimensions: 5 m*0.53 mm*0.15 um

Carrier gas: Helium

Start temp: 50° C.

Ramp 1: 50° C.-350° C., 10° C./min

Ramp 2: 350° C.-430° C., 5° C./min

End temp: 430° C. (for 5 minutes)

Injector

House: Agilent housing where conductive heater is removed and replaced by coils for inductive heating.

Coil: 10 double windings of copper band (5×2 mm) isolated by glass tubes. Winding density towards sample inlet about 4-5 mm between windings and at column outlet of the injector at column winding density is about 1-2 mm between windings.

Frequency: 30 kHz

Sample: Manual injections (heated syringe, heated sample 90° C.)

Start temperature: 70° C.

Ramp: 120° C./s

End temperature: 450° C.

Column pressure: 35 kPa constant pressure (±50 ml/min@ 50° C.).

Split ratio: ±1:1

Gas Chromatograph

GC: Agilent 5890 series II

Liner: Altech split liner with glasswool

Detection

Type: FID

Temperature: 450° C. (nitrogen off)

H2 flow: 36 ml/min

Air flow: 360 ml/min

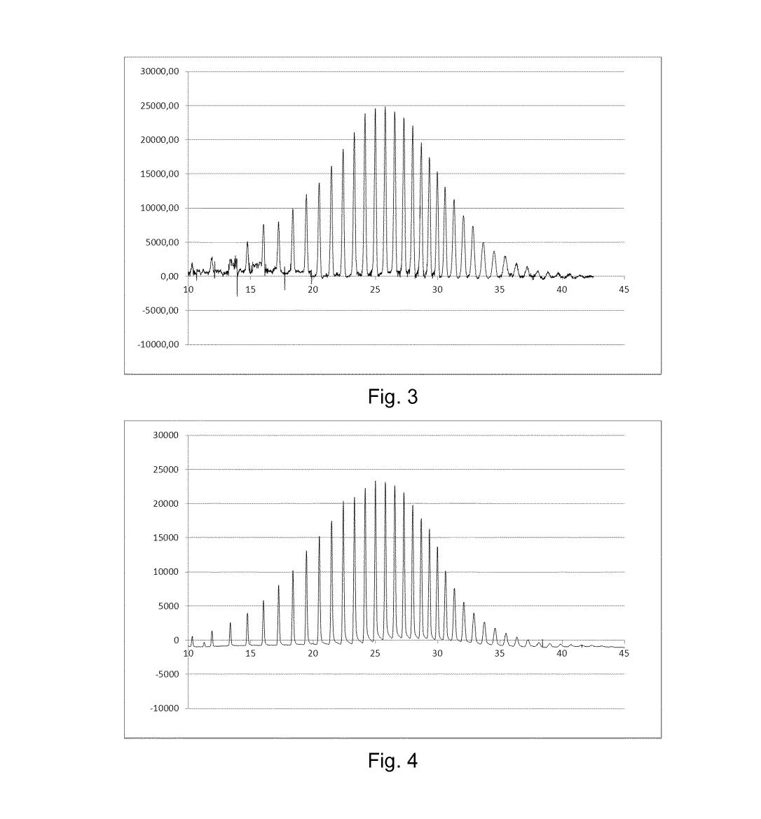

The resulting chromatogram is shown in FIG. 3.

### Test b:

A sample was prepared and gas chromatographic analysis was conducted in a cold-on-column test under comparable conditions as in Test a except that the sample was injected directly into the column, so the injector of Test a was not utilized.

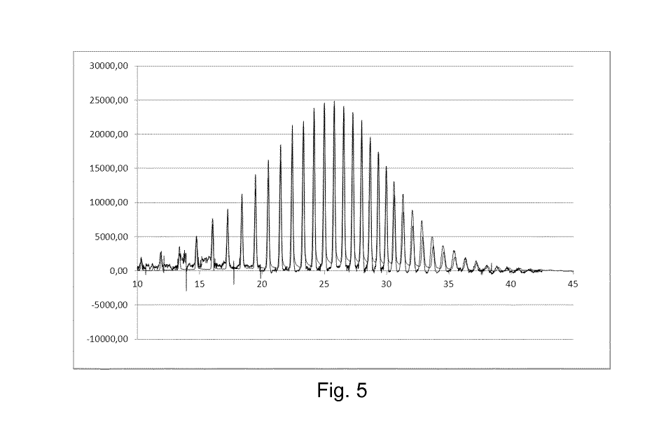

The resulting chromatogram is shown in FIG. 4.

Cold-on-column is considered the ideal conditions for gas chromatographic analysis with respect to compound recovery and in an ideal situation, whereas Split or Splitless flow conditions typically lead to increasing discrimination for heavier compounds. In FIG. 5 where both the results in FIG. 3 and FIG. 4 are included to facilitate comparison of the results it is therefore very surprising that the results of the present injector system closely resembles the results corresponding to the cold-on-column experiment—both with respect of peak distribution. The injection system according to the invention therefore leads to very reliable introduction of the sample into the column.

1. An injector for use in gas phase analytical systems and methods comprising a metal housing, provided with a carrier gas inlet, a split outlet, a column outlet of the injector, a sample inlet, a liner, and a heater device comprising at least one coil for radio frequency inductive heating the housing with a predetermined temperature program and for providing a predetermined spatial temperature profile in the injector.

2. The injector according to claim 1, wherein the coil for inductive heating is placed around the housing from the beginning of the liner until at least the column outlet of the injector.

3. The injector according to claim 1, wherein the coil for inductive heating is wound with a winding density increasing from sample inlet to column outlet of the injector.

4. The injector according to claim 1, wherein a first coil for inductive heating is provided around the housing, and a second coil for inductive heating is provided close to the column outlet of the injector.

5. The injector according to claim 1, wherein the at least one coil for inductive heating is provided in such way that a spatial temperature profile with monotonically increasing temperature from sample inlet of the injector to the column outlet of the injector is provided.

6. The injector according to claim 5, wherein the temperature at the column outlet of the injector is at least 5° C. higher than at the sample inlet of the induction heated housing.

7. The injector according to claim 1, wherein an electrical isolation layer is provided between coil for inductive heating and outer surface of the housing.

8. The injector according to claim 1, wherein the heater device comprises a heating element comprising at least one coil for inductive heating enclosed in a non-conductive container.

9. The injector according to claim 8, wherein the heating element is further provided with connecting means to connect the coil for inductive heating to a heater controller, and with an inlet and outlet for a gas flow.

10. A process of making an injector according to claim 1, comprising the steps of providing an S/SL injector comprising a metal housing, provided with a carrier gas inlet, a split outlet, a column outlet of the injector, a sample inlet, a liner, and a heating block; removing the heating block from the injector; and providing at least one coil for inductive heating around the housing.

11. A process of refitting an existing S/SL injector, comprising the steps of providing an injector comprising a metal housing, provided with a carrier gas inlet, a split outlet, a column outlet of the injector, a sample inlet, a liner, and a heating block; and replacing said heating block by a heating element as defined in claim 8.

12. A heater device comprising a heating element as defined in claim 8 and a heater controller.

13. A gas phase analytical system comprising an injector according to claim 1.

14. A process of providing a sample to a gas phase analytical system, like a GC system, according to claim 13, comprising a step of providing the sample to the injector.

15. A process of analysing a sample with a gas analytical system, like a GC system, according to claim 13, comprising a step of providing the sample to the injector.
